(19) United States
(12) Patent Application Publication
(10) Pub. No.: US 2024/0265684 A1
(43) Pub. Date: Aug. 8, 2024

(54) COMPUTER-IMPLEMENTED METHOD FOR THE DETECTION AND RECOGNITION OF OBJECTS IN UNLABELED IMAGE DATA USING AN AUTOMATED LABELLING ARCHITECTURE

(71) Applicant: NavInfo Europe B.V., Eindhoven (NL)

(72) Inventors: Haris Iqbal, Eindhoven (NL); Elahe Arani, Eindhoven (NL); Bahram Zonooz, Eindhoven (NL)

(21) Appl. No.: 18/163,792

(22) Filed: Feb. 2, 2023

(51) Int. Cl. G06V 10/774; G06V 10/764; G06V 10/82; G06V 20/58

(52) U.S. Cl. CPC G06V 10/7753; G06V 10/764; G06V 10/82; G06V 20/58

(57) ABSTRACT

A computer-implemented method for the detection and recognition of objects in unlabeled image data using an automated labelling architecture. The method includes the steps of: proposing bounding-box in every image of the unlabeled image data using a task specific and/or a related task pretrained object detection model and a Bounding Box Sampler module; filtering said bounding boxes for positive object instances; assigning to said filtered bounding boxes a class label using a Few-Shot Classification module; and modifying filtered bounding boxes based on additional class wise attention output from the Few-Shot Classification module.

### BACKGROUND OF THE INVENTION

### Field of the Invention

The invention relates to creating ground truth annotations/labels for object detection and classification for objects in image data in an autonomous driving scenario. Said image data may comprise a sequence of images from a video or images without a sequence.

### Background Art

The detection and recognition of objects in an autonomous driving scenario, in which image data is collected by at least one vehicle mounted camera, is crucial for road infrastructure maintenance and functioning. State-of-the-art approaches in this field use Artificial Intelligence (AI) models which customarily require training and testing on sufficiently large image datasets that contain ground truth labels. Large would here refer to the total amount of information contained in the datasets. Said ground truth labels are furthermore typically manually provided by humans. Therefore, an inordinately high cost is incurred for creating such datasets, wherein such cost is both measured in financial expenditure. By relying on humans to add truth labels one also incurs a cost measured in time.

One of the most prominent earlier attempts to remove costly human involvement in the label creation is called as Pseudo-Labels [1A]: Lee, Dong-Hyun. (2013). Pseudo-Label: The Simple and Efficient Semi-Supervised Learning Method for Deep Neural Networks. ICML 2013 Workshop: Challenges in Representation Learning (WREPL).

The approach first trains a model on a labelled subset of the data. The model architecture chosen is typically accuracy oriented rather than computational complexity oriented. In this exemplary attempt, inferences are created on the yet unlabeled subset in order to create labels. Even though the approach is simplistic, but somewhat effective. This method is heavily dependent on the model performance trained on the smaller labelled data. The labels, thus created, will at best reach the accuracy of the trained model. The present invention aims to overcome this limitation.

Another significant approach [2A] uses object tracking on top of a pre-trained object detection model on a related task: Brouns, T., Arani, E., & Zonooz, B. (2022). Method and system for generating ground-truth annotations of roadside objects in video data. U.S. patent application Ser. No. 17/482,339.

In this second approach unexpected tracks are filtered out using domain prior knowledge. High confidence tracks are passed through a classifier trained on a required task using a small labelled dataset and labelled with classifier output consensus. The tracks with lower confidence are subsequently passed to a human annotator to get labelled. Hence, this is a semi-automated approach which works only on a sequenced image data from a video with a relatively high frame rate. Additionally, this requires a pretrained high accuracy detection model. For example, a general traffic sign detector is required for ‘specific’ traffic sign annotations. The present invention aims to overcome this need for pretraining.

This application refers to a number of publications. Such references are not to be considered that such publications are prior art for purposes of determining patentability.

### BRIEF SUMMARY OF THE INVENTION

One object of the present invention is to overcome the limitations or at least improve traditional systems and methods by labelling a dataset to improve the accuracy of the same model which created the labels.

The approach of the invention is different from [1A] in using additional supervision from a semantic segmentation model to filter out the region where one would not expect the objects to occur. Additionally, embodiments of the invention present a novel Bounding Box Sampler (BBS) to create proposal crops which can be labelled. Moreover, the invention may use the latest few-shot learning approach to associate a label to these crops rather than a simple classifier.

The invention further differs from [2A] in that it uses a semantic segmentation model to reduce the relevant search area and the use of the BBS module to create proposal bounding boxes. For example, for road damage detection annotations. The invention uses road segmentation from semantic segmentation model; and for license plate detection annotations, the invention may use vehicle segmentation from semantic segmentation model. A semantic segmentation model for this kind of supervision is relatively easily available for a variety of tasks.

Additionally, the invention does not require a sequenced data since the invention does not use an object tracker. Moreover, the few-shot learning approach provides better estimates of labels as compared to naive classifier by means of its implementation in the invention.

A method according to the invention provides an efficient pipeline for labelling bounding box object detections on new data to adapt the object detection model to new data. It uses a small amount of object detection labelled data on the current task and another pretrained model that can provide a decent prior knowledge about object categories in the task. Using prior knowledge, it extracts proposal bounding boxes with our innovated ‘Bounding Box Sampler’(BBS). A bounding box can be seen as the smallest rectangle with vertical and horizontal sides that surrounds an object. Then, the proposal bounding boxes are labelled using Few-Shot Learning approach. Using minimal pre-labelled data, a huge amount of new data can be labelled without further human intervention which reduces the labelling cost significantly thus making labelling a scalable problem and in turn makes the AI models generalizable to new unseen data.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a schematic illustration showing a flow chart for an automated labelling architecture for executing a computer-implemented method for the detection and recognition of objects in unlabeled image data (UID) according to an embodiment of the present invention;

FIG. 2 is a schematic illustration showing a flow chart of an example of a pretrained feature extractor with Resnet-34 architecture according to an embodiment of the present invention; and

FIG. 3 is a schematic illustration showing a flow chart of a CrossTransformer according to an embodiment of the present invention.

### DETAILED DESCRIPTION OF THE INVENTION

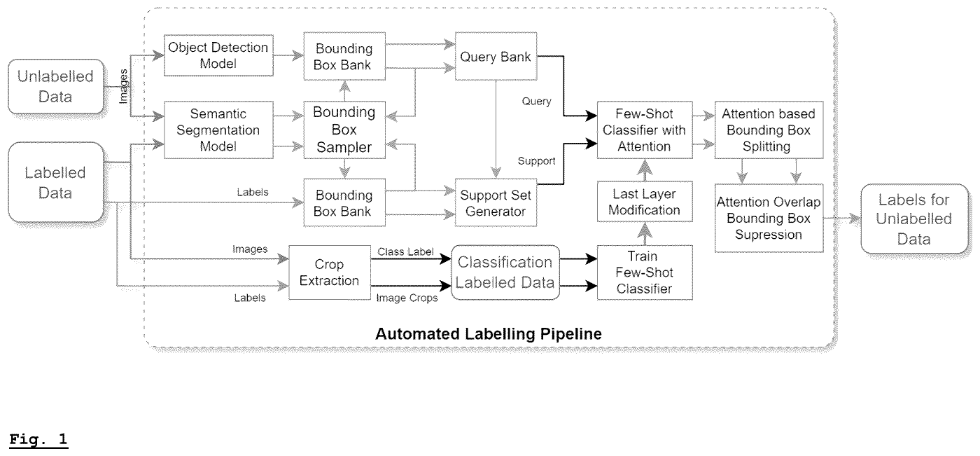

FIG. 1 shows an automated labelling architecture 1 programming for executing a computer-implemented method for the detection and recognition of objects in unlabeled image data (UID). Said detection and recognition of objects being translated into labels for the unlabeled image data (LUID). The before mentioned is true also separate from this specific exemplary embodiment.

As input the architecture relies on unlabeled image data (UID) from at least one camera mounted to an at least partially autonomous driving vehicle in an autonomous driving scenario. The term scenario can be understood to be any situation wherein the associated vehicle is being driven. This also comprises parking. There is no distinction between an autonomous driving scenario and a driving scenario in general other than the fact that the vehicle's actions are substantially exclusively controlled by a computer.

For the purpose of clarity, the terms in the Figure are first introduced.

Pre-Labelled Image Data (PID): For the auto-labelling architecture 1 according to the invention a relatively small labelled image dataset on a corresponding task is provided. In example, wherein one wishes to label unlabeled image data (UID) for road damage object detection task with the following classes: linear cracks, alligator cracks and potholes; one would require a comparatively small dataset labelled with same classes as object detection bounding boxes on still images.

Classification Labelled data (CLD): is generated using detection bounding boxes from the pre-labelled image data, crops are extracted from the same label data, and the class of the detection bounding boxes is assigned to the features.

Unlabeled Image Data (UID): Unlabeled image data in the form of still images or frames extracted from a video. This is the target data that the invention aims to detection and recognize objects in. Such detection and recognition culminating in the labelling of this unlabeled image data.

The architecture 1 also shows several artificial intelligence models:

Semantic Segmentation Model (SSM): A semantic segmentation model pre-trained on classes which are suitable to provide a defined portion within an image of the unlabeled image data wherein the detection of objects is able to occur. For example, the detection of road damages occur only on portions of an image comprising road, such as the bottom half of any image, and therefore, a semantic segmentation model, which can segment the road in an image from the rest of the image, may be used here. Similarly, license plates occur only on that portion of the image containing the vehicle. A semantic segmentation model which can segment vehicles may be used for the task of labelling license plates.

### Task Specific Detection Model, Also Known as a Pretrained Object Detection Model

(ODM): To improve performance, the architecture 1 may comprise a detection model trained on an exact task associated with an object or a related task associated with an object that is to be detected within an image of the unlabeled image data. That is to say the ODM may be used for:
A specific task for which limited training data in the form of pre-labelled image data (PID) is available. This will result in a low accuracy detection model on these same classes. This model can however be used to provide a first estimate of possible instances.
A task for detecting a super-category of an object. For example, having the ODM trained to detect a traffic sign, without identifying which traffic sign. This will result in a higher accuracy model, wherein detecting a superclass of what is required in the task. Hence, this allows the architecture to get a good estimate of positive instances without class labels.

Task Specific Few-Shot Object Classification Model (FSC): Additionally, the architecture comprises a few-shot classification model trained on the ‘classification labelled data’ described herein above. This model is trained on the same set of classes that are considered for object detection labels with an additional class representing a negative sample.

The architecture 1 is effective by first proposing bounding-box candidates in every image of the unlabeled image data using the task specific or related task pretrained object detection model as well as our Bounding Box Sampler (BBS) module. Thereafter, the pipeline uses our Few-Shot Classification (FSC) module to assign each of these candidate bounding boxes to the correct class label if it is a positive sample or filter it out if it is a negative sample. In addition, bounding box sizes and instances are modified based on additional class wise attention output from the FSC module.

The purpose of the BBS module is to generate candidate bounding box object detections. The sampling of the proposal bounding boxes works by first using the pretrained semantic segmentation model to segment the region of interest in the image. Subsequently, the invention obtains a mask of the region of interest excluding the region covered by all the already sampled bounding boxes. Next, a random pixel is sampled from within the mask, and a random bounding box is placed around it. The size and aspect ratio of the bounding box are sampled to be comparable to the ones in the labelled dataset. The bounding boxes which are outside the original region of interest, obtained from the semantic segmentation model, beyond a percentage area threshold are removed. These proposed bounding boxes can still be overlapping among themselves. This Bounding Box Sampler is employed to get samples from regions where the invention may not have any prior knowledge, like manual labels.

The proposed bounding boxes are then sent to the FSC module which determines whether any object of interest is present in the bounding box or not, and if it is, additionally classifies the type of the object. To make this classification process generalize well to Out of Distribution (OOD) data, the invention may use the few-shot learning technique. Unlike the usual method of training where the model is trained end-to-end on training data and validated on labelled validation data, few-shot learning involves learning from a given small subset of the labelled data as reference and making predictions based on those references. The subset of labelled images that is given to the model as a reference is called a support set while the unlabeled images to be processed are called the query set. The few-shot learning method matches feature correspondences between the query and the support set to find the nearest neighbor in feature space, which is then predicted as the label for the query.

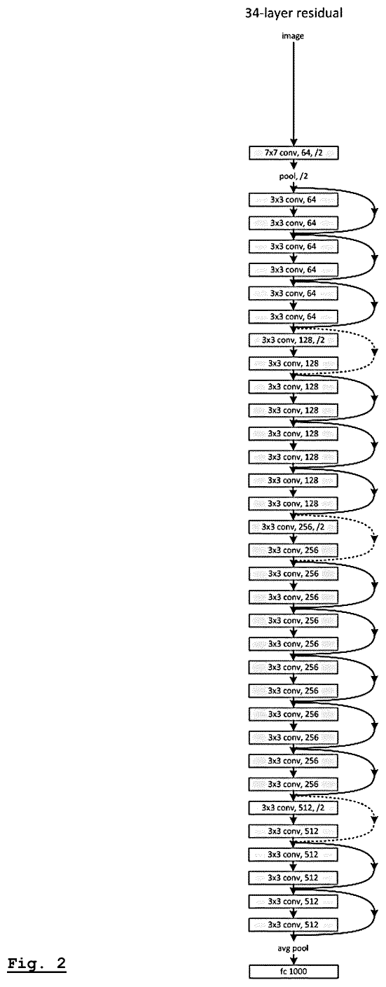

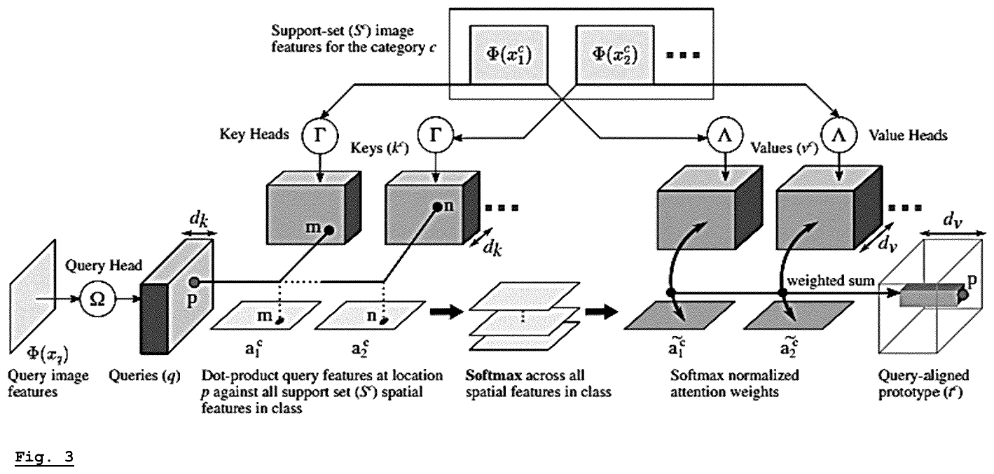

The FSC module is trained and modified in the following steps. First, a pretrained feature extractor like Resnet [1B], trained on a diverse visual task, is used to aid the few-shot learning. The feature ϕ extracted here are the embeddings produced by a pretrained deep neural network classifier just before the last classification layer. The pretraining can be any diverse related dataset like ImageNet[3]. Then, the FSC, which includes the pretrained feature extractor (FIG. 2) and a trainable neural network-based architecture (FIG. 3) which finds the distance between a query and support set, is trained on the classification labelled data described earlier. For our approach, the trainable neural network-based architecture should also compare spatial correspondences between query and support set images for each class. An example of such an architecture is Cross Transformer [2B]. The invention may see the last layer of the architecture modified to output these spatial correspondences as attention maps. Wherever the spatial correspondence between a region in query image with a specific region in a specific class support set, the invention assigns high attention to that region for that class. At the end, the architecture may apply SoftMax over classes to get scaled attention.

For completeness sake, an example of a Resnet architecture is given in [1B] and an example of a Cross Transformer is given in [2B]:
1B. Kaiming He, Xiangyu Zhang, Shaoqing Ren, & Jian Sun (2015). Deep Residual Learning for Image Recognition. CoRR, abs/1512.03385.
2B. Carl Doersch, Ankush Gupta, & Andrew Zisserman (2020). CrossTransformers: spatially-aware few-shot transfer. CoRR, abs/2007.11498.

FIG. 2 shows an example of a pretrained feature extractor with Resnet-34 architecture. For feature extraction, the architecture may be designed to remove the last avg pool and fc 1000 layer. From an image x, it extracts ϕ(x) features.

FIG. 3 shows a CrossTransformer. The more general concept of a CrossTransformers is known from [3]: Russakovsky, O. et al. (2014) ‘ImageNet Large Scale Visual Recognition Challenge’, CoRR, abs/1409.0575. Available at: http://arxiv.org/abs/1409.0575.

In the example of FIG. 3, image extracted features ϕ(.) are passed to the trainable neural network-based distance calculator. The features are passed through (support) Key Heads and Query (key) Head and then, the dot product between them provides a spatial similarity. This spatial similarity is then soft-maxed across all spatial features in class to get scaled spatial similarity within a class. The architecture 1 treats this spatial similarity as ‘per class spatial attention’. These attention maps are used to calculate weighted sum from the value head. In addition to FIG. 3, the architecture takes the per class spatial attention map for each class and take softmax across classes to get class scaled attention map.

Typical application areas of the invention include, but are not limited to:
Road condition monitoring
Road signs detection
Parking occupancy detection
Defect inspection in manufacturing
Insect detection in agriculture
Aerial survey and imaging

Although the invention has been discussed in the foregoing with reference to an exemplary embodiment of the method of the invention, the invention is not restricted to this particular embodiment which can be varied in many ways without departing from the invention. The discussed exemplary embodiment shall therefore not be used to construe the append-ed claims strictly in accordance therewith. On the contrary the embodiment is merely intended to explain the wording of the appended claims without intent to limit the claims to this exemplary embodiment. The scope of protection of the invention shall therefore be construed in accordance with the appended claims only, wherein a possible ambiguity in the wording of the claims shall be resolved using this exemplary embodiment.

Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another.

Optionally, embodiments of the present invention can include a general or specific purpose computer or distributed system programmed with computer software implementing steps described above, which computer software may be in any appropriate computer language, including but not limited to C++, FORTRAN, ALGOL, BASIC, Java, Python, Linux, assembly language, microcode, distributed programming languages, etc. The apparatus may also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements. One or more processors and/or microcontrollers can operate via instructions of the computer code and the software is preferably stored on one or more tangible non-transitive memory-storage devices.

What is claimed is:

1. A computer-implemented method for the detection and recognition of objects in unlabeled image data (UID) using an automated labelling architecture, the method comprising the steps of:
proposing bounding-box in every image of the unlabeled image data using: a task specific and/or a related task pretrained object detection model; and a Bounding Box Sampler (BBS) module;
filtering the bounding boxes for positive object instances;
assigning to the filtered bounding boxes a class label using a Few-Shot Classification (FSC) module; and
modifying filtered bounding boxes based on additional class wise attention output from the Few-Shot Classification module.

2. A computer-implemented method for the detection and recognition of objects in unlabeled image data (UID) using an automated labelling architecture, the method comprising the steps of:
collecting said image data (UID) from at least one camera mounted to an at least partially autonomous driving vehicle in an autonomous driving scenario;
filtering out regions of images, comprised in the unlabeled image data, based on a reduced expectation of the occurrence of an object in the filtered out regions; and
labelling the image data for object detection and classification of objects in the image data that has passed through the filtering step,
wherein the filtering step is performed using supervision from a semantic segmentation model for a plurality of tasks,
wherein the reduced expectation of the occurrence of the object in the filtered out regions is based on a task that is selected from the plurality of tasks, wherein the selected task is associated with the object, and
wherein the labelling the unlabeled image data (UID) at least partially relies on pre-labelled image data (PID) corresponding to the task.

3. The method according to claim 1, wherein filtering comprises proposing bounding boxes for the images comprised in the image data for labelling to generate candidate bounding box object detections.

4. The method according to claim 3, wherein labelling comprises determining the presence or absence of an object of interest within such proposed bounding boxes using Few-Shot Classification and classifying the object when present.

5. The method according to claim 4, wherein sizes and instances of the bounding boxes are modified based on additional class wise attention output from the Few-Shot Classification module.

6. The method according to claim 3, wherein bounding boxes are sampled by:
using a pretrained semantic segmentation model to segment the portions of interest in a corresponding image;
obtaining a mask of the portion of interest in the corresponding image excluding the portion of the corresponding image covered by at least some bounding boxes that have been sampled previously; and
sampling a random pixel from within said mask, and placing a bounding box around it.

7. The method according to claim 6, wherein the size and aspect ratio of the bounding box are sampled to be within a threshold percentage of the corresponding image area compared to bounding boxes within in an already labelled dataset, and wherein those bounding boxes which are outside of an original image portion of interest, obtained from the semantic segmentation, beyond a percentage area threshold are removed.

8. The method according to claim 5, wherein the Few-Shot Classification module comprises a pretrained feature extractor and a trainable neural network-based architecture which is designed to find the distance between a query and a support set of pre-labelled image data, and wherein the trainable neural network-based architecture is trained on the classification labelled data.

9. A data processing apparatus comprising means for carrying out the method of claim 1.

10. A computer program product comprising instructions which, when the program is executed by a computer, cause the computer to carry out the method of claim 1.

11. An at least partially autonomous driving system comprising:
at least one camera designed for providing a feed of input images;
a computer designed for classifying and/or detecting objects using a deep neural network; and
wherein said deep neural network has been trained, or is actively being trained, using the method according to claim 1.
